(19) United States
(12) Patent Application Publication
(10) Pub. No.: US 2014/0085297 A1
(43) Pub. Date: Mar. 27, 2014

(54) PLACEMENT OF INFORMATION FIELDS WHEN DISPLAYING A DIGITAL MEDICAL DATASET

(71) Applicants: Gerhard Krämer, Igensdorf (DE); Katja MOGALLE, Ilmenau (DE); Nora PAN, Summertown Oxford (GB); Grzegorz SOZA, Heroldsberg (DE); Christian TIETJEN, Fuerth (DE)

(72) Inventors: Gerhard Krämer, Igensdorf (DE); Katja MOGALLE, Ilmenau (DE); Nora PAN, Summertown Oxford (GB); Grzegorz SOZA, Heroldsberg (DE); Christian TIETJEN, Fuerth (DE)

(73) Assignees: SIEMENS PLC, Sheffield (GB); SIEMENS AKTIENGESELLSCHAFT, Munich (DE)

(21) Appl. No.: 14/031,114

(22) Filed: Sep. 19, 2013

(30) Foreign Application Priority Data
Sep. 21, 2012 (DE) 102012217068.5

(51) Int. Cl. G06T 11/60; G06T 19/20

(52) U.S. Cl. CPC G06T 11/60; G06T 19/20
USPC 345/419; 345/629

(57) ABSTRACT

A method is disclosed for displaying a digital medical image dataset. In an embodiment of the method, when a new set of diagnostic findings is generated, an associated new information field is also generated. A number of possible positions are determined for the new information field. Each of the positions is assigned an evaluation metric in accordance with a number of predefined criteria. The new information field is in this case arranged at that position having the best evaluation metric. Each existing information field that overlaps with the new information field is shifted until the existing information field is arranged free of overlap with the new information field. Other existing information fields that overlap with previously shifted information fields are shifted until all of the information fields are arranged free of overlap with one another.

### PRIORITY STATEMENT

The present application hereby claims priority under 35 U.S.C. §119 to German patent application numbers DE 102012217068.5 filed Sep. 21, 2012, the entire contents of which are hereby incorporated herein by reference.

### FIELD

At least one embodiment of the invention generally relates to a method for displaying a digital medical dataset. At least one embodiment of the invention furthermore generally relates to a device and/or to a computer program product for displaying a digital medical dataset.

### BACKGROUND

One consequence of the development and spread of imaging methods such as computer tomography (CT), magnetic resonance tomography (MRT) and digital radiography is that the computer has become indispensable in the field of medicine also. In this context the acquired digital image data is studied and evaluated by radiologists at specialized computers (known as diagnostic findings assessment stations). High-resolution 2D and 3D representations of the interior of the body find application primarily in prevention, diagnosis and treatment, since with the aid of the visualizations it is possible to examine patients non-invasively, but nonetheless with very great precision. Software systems that accompany and support the diagnostic findings process can be used among other things for correlating all the information collected during the examination in an orderly manner in a set of diagnostic findings in order to obtain an exhaustively documented (electronic) patient record.

Information fields (also referred to as “annotations” or “labels”) constitute a powerful tool in the diagnostic appraisal of image data. The term “information field” in the present context denotes a text field which can be displayed together with the image data and which is assigned to a specific set of findings. The term “findings”—in its strictly image-processing sense—signifies a group of picture elements (pixels) which is marked as belonging together. This can be the segmented image of a tumor, for example, or an image region selected as a result of a user interaction. Such selected image regions can be limited to a surface area of a two-dimensional image slice and are then referred to as an ROI (Region of Interest). In the case of three-dimensional image data (volume data), which consists of a plurality of in each case two-dimensional image slices that are aligned in series along a third dimension, a selected image region can also extend over a plurality of image slices adjoining one another. Such an image region is also referred to as a VOI (Volume of Interest).

An information field of the aforementioned type is usually realized as a simple text element which is embedded in the image that is to be displayed and in the process locally conceals the actual image information.

In practice, image datasets are examined by a radiologist following their acquisition. During this process evident pathological structures are marked as diagnostic findings and comments are inserted in the respective associated information fields in order to document the medical significance of the findings. The medical experts taking part in an interdisciplinary case discussion can simply exchange the commented image data among themselves and reach a fresh assessment. In this case the information fields allow a quick and clearly arranged, but also well-grounded presentation of the medical case. Such information fields can also be used as a way of keeping patients informed, communicating details to the patients in a visual and hence easily intelligible form.

Because an image dataset and in particular also an image slice of a volume dataset can contain several, sometimes even many information fields, there is the risk that medically relevant image information will be overshadowed by the number of information fields and consequently may be easily overlooked. For this reason the way in which the information fields are arranged within the image slices that are to be displayed is extremely important.

What is desirable in this case is an automatic arrangement of the information fields in order to relieve the physician assessing the diagnostic findings of this purely editorial activity. On the other hand it is preferable for the information fields to be arranged in a clearly structured and easily intelligible manner in order to facilitate further processing of the images and avoid misinterpretations. Finally, however, it should also be possible to arrange the information fields in a simple, numerically uncomplicated manner so that no significant delay in displaying the image will occur due to the arrangement of the information fields even in the case of large image datasets containing many information fields and/or of rapid switching between different image slices.

### SUMMARY

A method, a device and a computer program product are disclosed which are particularly suitable for displaying a digital medical image dataset in view of the requirements cited hereintofore.

At least one embodiment is directed to the method, the device, and the computer program product. Advantageous and in some cases per se inventive embodiments and developments of the invention are set forth in the dependent claims and the following description.

The method according to an embodiment of the invention serves for displaying a digital medical image dataset, more precisely for editing a digital medical image dataset for the purpose of displaying the same on a screen or some other visual display device. The image dataset can be a two-dimensional image dataset comprising only a single image slice in the form of a two-dimensional arrangement of pixels spanning an image plane. Preferably, however, the method serves for displaying a three-dimensional image dataset (volume dataset), for example a computer tomogram that has a plurality of in each case two-dimensional image slices aligned in series along a third dimension.

The device according to an embodiment of the invention comprises a display unit for the visual presentation of digital image datasets, in particular a screen. The device additionally comprises a data processing unit. A display program for editing the image dataset in preparation for display on the display unit is implemented on the data processing unit (i.e. a computer), which within the scope of the invention can be in particular a personal computer (PC) or a workstation. The display program is in this case configured for performing the method according to the invention in one of its above-described embodiment variants.

The computer program product according to an embodiment of the invention comprises computer-readable instructions of a display program, the method according to the invention being automatically performed in one of the above-described embodiment variants on the basis of the instructions when the display program is executed in a data processing unit.

### BRIEF DESCRIPTION OF THE DRAWINGS

An example embodiment of the invention is explained in more detail below with reference to a drawing, in which:

FIG. 1 is a schematically simplified block diagram depicting a computed tomography scanner and an associated device for displaying a digital medical image dataset, which device comprises an image memory, a screen and a data processing unit having a display program implemented therein,

FIG. 2 is a schematic representation of a two-dimensional image slice of the (three-dimensional) image dataset that is to be displayed, wherein two sets of diagnostic findings, each having an associated information field, are assigned to the image slice,

FIG. 3 is a schematically simplified flowchart showing a method performed by the data processing unit during the execution of the display program for the purpose of placing the information field assigned to a new set of diagnostic findings when displaying the image slice,

FIGS. 4-7 show, in each case visualized in a representation according to FIG. 2, four consecutive method steps of the method according to FIG. 3, and

FIG. 8 is a schematic flowchart showing a method performed by the data processing unit during the execution of the display program for the purpose of placing information fields in the course of a “scroll process”, i.e. when switching between different displayed image slices of the image dataset.

Mutually corresponding parts, magnitudes and structures are systematically labeled with the same reference signs in all the figures.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The method according to an embodiment of the invention serves for displaying a digital medical image dataset, more precisely for editing a digital medical image dataset for the purpose of displaying the same on a screen or some other visual display device. The image dataset can be a two-dimensional image dataset comprising only a single image slice in the form of a two-dimensional arrangement of pixels spanning an image plane. Preferably, however, the method serves for displaying a three-dimensional image dataset (volume dataset), for example a computer tomogram that has a plurality of in each case two-dimensional image slices aligned in series along a third dimension.

The term “image slice” in the present context refers to a two-dimensional section (basically of arbitrary orientation) through the three-dimensional image information of the image dataset.

The image dataset that is to be displayed additionally comprises a number of diagnostic findings, each of which—according to the above definition—is formed by a subgroup of pixels marked as belonging together. For each set of findings, the image dataset lastly includes an associated information field containing text data. Within the scope of the image dataset, the or each information field is in this case not stored as part of the image information (in other words, not in the form of color or grayscale values). Rather, the information relating to the information fields is stored independently of the actual image values of the image dataset. In this case the textual content associated with each information field as well as optional specifications relating to the size and/or the graphical embodiment of the information field are stored in electronically readable form (e.g. in the form of ASCII codes).

For presentation purposes, each information field is preferably connected by way of a visible reference line to a predefined anchor point at the edge of or within the associated diagnostic findings in order to make clear the association between the reference field and the findings.

In this case the method according to an embodiment of the invention serves in particular for the placement of the or each information field on the image plane such that the image data can be displayed together with the superimposed text information of the information fields. An important aspect of the method according to an embodiment of the invention consists here in interpolating a newly generated information field into the already existing information fields.

For this purpose it is provided according to the method that an associated new information field will be generated during the generation of a new set of findings, for example by way of automatic segmentation or manual selection by a user. Preferably the new information field is generated in interactive cooperation between a display program and a user, whereby the display program automatically generates an empty mask for the information field, in which mask the user enters the text that is to be displayed. However, it can also be provided within the scope of the invention for all or part of the text information of the information field to be generated automatically.

Within the scope of the method the newly generated information field is placed with high priority, possibly to the detriment of already existing information fields. For this purpose a number of possible positions are first determined for the new information field. In this case the positions are preferably chosen such that the information fields are placed at least in the main at the edge of the image plane, i.e. at the edge of the image slice or—if only a part of the image slice is displayed—at the edge of the displayed image section. In this case the position of the center of the surface area of the information field in units of an image coordinate system is preferably drawn upon as a measure for its position. However, a different definition of the field position is also possible in principle within the scope of the invention. For example, the top left-hand corner of the information field could also be used as a measure for its position.

In addition, within the scope of the method, an assigned evaluation metric is determined for each of the determined possible positions in accordance with a number of predefined criteria. The new information field is in this case arranged at the best position, i.e. at that position having the best evaluation metric.

If an already existing information field overlaps with the new information field, the existing information field is shifted, preferably along the edge of the image plane or the displayed image section (continuously or in discontinuous steps), until the existing information field is arranged free of overlap with the new information field.

If at least one further existing information field comes to overlap with the previously shifted information field, the further existing information field is again shifted, again preferably along the edge of the image plane or the displayed image section, until it is arranged free of overlap with the previously shifted information field. This step is repeated iteratively until all the information fields are arranged adjacent to one another without overlap.

The above shifting or displacement principle has the advantage that information fields relating to new findings, which are often of exceptional importance for the diagnostic appraisal process on account of their newness, are placed conspicuously and in a readily identifiable manner, thus improving the “readability” of the displayed images. In this case the shifting or displacement principle creates significant numerical overhead only if the “optimal” placement of the new information field leads to conflicts with already existing information fields. Thanks to the iterative, successive shifting of the existing information fields, such overlap conflicts are in this case resolved with particularly little overhead on average and mostly with a satisfactory result.

In a refined variant of the method the original positions for the new information field are chosen such that no set of findings is covered by the new information field. The existing information fields are preferably shifted subject to the same condition. The or each existing information field that overlaps with the new information field or a previously shifted information field is therefore shifted so that it does not overlap with any diagnostic findings. In contrast, possible positions in which the new information field or an existing information field would overlap with a diagnostic finding are identified as invalid and rejected.

In a beneficial embodiment variant the method serves for displaying image datasets which, in addition to one or more information fields, each of which is assigned to a set of diagnostic findings, comprise an image label which is independent of the findings. The image label contains for example the name of the imaged patient, the date and type of the image acquisition, details concerning the modality used, information on image acquisition parameters, the number of the associated electronic patient record, etc. In this case, in the course of the method, the possible positions of the new information field are preferably chosen subject to the additional condition that the new information field is arranged free of overlap with the findings-independent image label. In this variant of the method the existing information fields are also shifted such that they are arranged free of overlap with the image label.

In the interests of effective determination of the position for the new information field, in a beneficial embodiment of the method a positioning frame in the form of a closed track is determined on the image plane, along which track the position of the new information field can be shifted. If the center of the surface area of the information field that is to be placed is used as reference for the field position, the positioning frame is beneficially determined such that it has a clearance equivalent to half the width of the information field with respect to the side edges of the image plane or the displayed image section. Correspondingly, the positioning frame has a clearance equivalent to half the height of the information field with respect to the top and bottom edge of the image plane.

If, according to the method, the findings-independent image label is to be excluded from the placement and shifting of the information fields, the positioning frame is preferably determined such that the new information field will be arranged free of overlap with the image label in any position. In particular the positioning frame runs around each element of the findings-independent image label with a clearance equivalent to half the field width or height. In this case the positioning frame frequently has a non-rectangular geometry.

Essentially, it can be provided within the scope of an embodiment of the invention that the information field can be shifted continuously on the positioning frame. In this case each pixel coordinate lying on the positioning frame forms a possible position for the information field. In order to keep the numerical overhead for the positioning of the information fields to a minimum, however, in a preferred implementation of the method a number of discrete pixel coordinates spaced apart from one another are designated as possible positions for the information field on the positioning frame.

A method referred to as “ray fan” is preferably employed in at least one embodiment for determining these points. According to this method, a fan of radial rays is formed starting from a center within the image plane. Each of the radial rays is assigned to a possible position of the new information field insofar as the possible positions of the new information field are chosen such that a possible position lies on each of the radial rays. In this case the center from which the radial rays are emitted is beneficially chosen such that it lies inside, in particular in the center of the surface area, of that set of diagnostic findings to which the new information field is assigned. The individual radial rays are in this case beneficially aligned at equal angular intervals from one another. For example, the ray fan 36 comprises radial rays that are each aligned at angular intervals of 10° from one another.

If a positioning frame is defined in the course of the method as described above, a possible position for the new information field is formed in each case by the point of intersection of each radial ray with the positioning frame. Basically, however, the concepts of the positioning frame and the ray fan can also be applied independently of each other within the scope of the invention. Thus, it is conceivable for the possible positions for the new information field on the positioning frame also to be determined in a different way, at predefined pixel intervals for example. Equally, a ray fan can also be used in method variants for determining the possible positions in which a positioning frame is not, at least not explicitly, defined.

Preferably one or more of the following criteria are tested in order to determine the evaluation metric for each of the possible positions of the new information field:
The new information field should as far as possible not cover the actual image information, i.e. the areas of the image plane having contrasting colors, but should lie completely on the monochrome image background.
The information field should as far as possible lie at the edge of the image plane, i.e. of the image slice or the displayed image section.
The new information field should as far as possible be arranged vertically over or under the associated diagnostic findings or horizontally next to the associated diagnostic findings. In other words, the route or connecting line formed between the possible position of the new information field and an anchor point at the edge of or inside the associated diagnostic findings should be parallel to one of the edges of the image plane. If the new information field is connected to the associated diagnostic findings by way of a reference line, the reference line should as far as possible extend vertically or horizontally.
The new information field should be arranged as close as possible to the associated diagnostic findings. In particular the optionally provided reference line between the new information field and the associated diagnostic findings should be as short as possible.

Preferably all the aforementioned criteria are tested in combination with one another. In this case the fulfillment of the or each tested criterion is incorporated positively into the evaluation metric.

In a beneficial embodiment of the invention the fulfillment or non-fulfillment of the tested criteria for every possible position of the new information field is mapped onto a measured value, the evaluation metric for the possible position being derived from the (possibly weighted) sum of the individual measured values.

If the placement of the new information field and/or, as a result thereof, the shifting of already existing information fields leads to an overlapping of the reference lines of information fields, in an advantageous implementation of the method the arrangement of the information fields is—exactly or at least approximately—swapped around in order to eliminate the overlapping of the reference lines. In other words, the positions of the information fields whose reference lines intersect are exactly or at least approximately interchanged.

If the image dataset that is to be displayed is a three-dimensional image dataset, provision is preferably made within the scope of the method for the possibility of performing image scrolling in which a plurality of adjacent image slices are displayed in succession. The image information of the three-dimensional image dataset is therefore worked through in the direction of the third dimension, in which the individual image slices are arranged in series. This process is also referred to hereinbelow as a “scroll process”.

In such image scrolling, information fields are preferably newly superimposed when the associated set of diagnostic findings becomes visible during image slice switching. Similarly, information fields are hidden when the associated set of diagnostic findings no longer becomes visible during the switching of the image slices.

In order to avoid a potentially confusing jumping back and forth of the displayed information fields during image scrolling, the position of information fields relating to diagnostic findings that are collectively contained in all the displayed image slices is preferably maintained at their previous position when the image slices are displayed. In the event of an overlap with the already displayed information fields, information fields that newly appear during the switching of the image slices are placed with a lower priority. A new placement of all of the information fields takes place only if no valid position between the already displayed information fields can be found for an information field that is to be placed in a new position as a result of the scroll process.

In an advantageous embodiment variant of the invention it is provided that information fields can be shifted not just automatically, but also “manually”, i.e. in accordance with a user interaction, for example in that a user “clicks on” a displayed information field with a pointer device, a computer mouse for example, and moves it to a different location. The position of such a manually shifted information field is preferably granted the highest priority. The position of such a manually shifted information field is therefore maintained at all times, even if the information field would overlap with a new information field or other information fields. Where necessary, the new information field and existing information fields are rearranged such that an overlap with the manually shifted information field is avoided.

The device according to an embodiment of the invention comprises a display unit for the visual presentation of digital image datasets, in particular a screen. The device additionally comprises a data processing unit. A display program for editing the image dataset in preparation for display on the display unit is implemented on the data processing unit (i.e. a computer), which within the scope of the invention can be in particular a personal computer (PC) or a workstation. The display program is in this case configured for performing the method according to the invention in one of its above-described embodiment variants.

The computer program product according to an embodiment of the invention comprises computer-readable instructions of a display program, the method according to the invention being automatically performed in one of the above-described embodiment variants on the basis of the instructions when the display program is executed in a data processing unit.

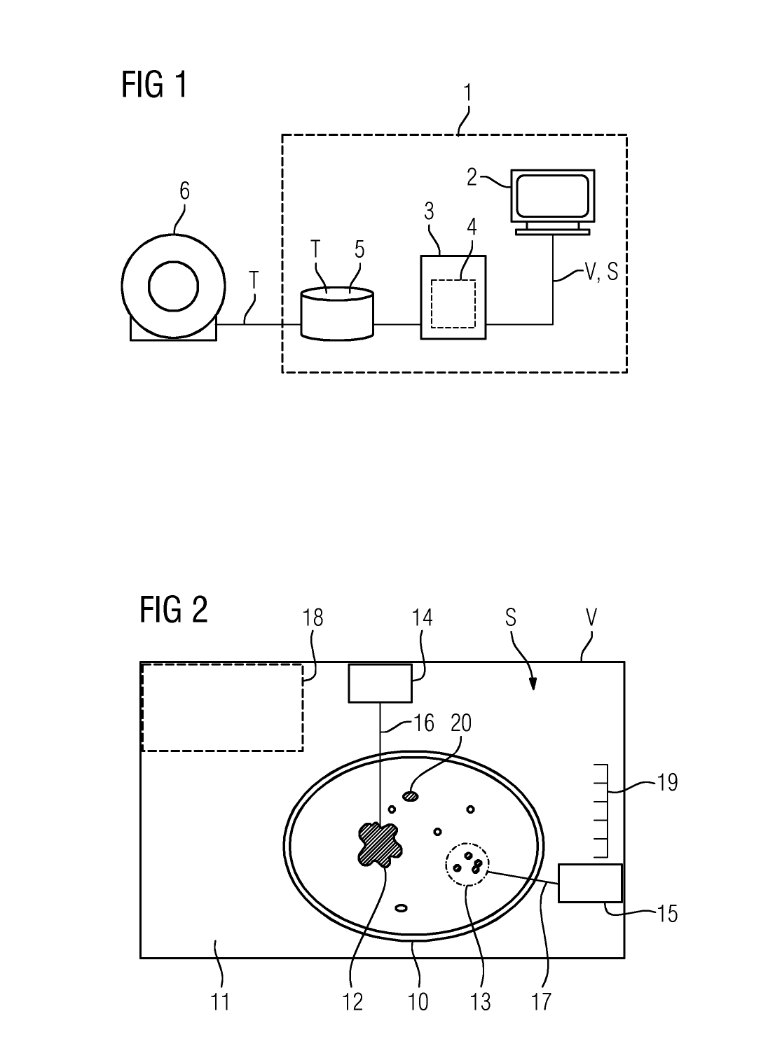

FIG. 1 shows, in a rough schematic simplification, a device 1 for displaying three-dimensional digital medical image datasets. The device 1 is in particular a so-called diagnostic findings assessment station, as used in the modern-day clinical environment for studying, editing and evaluating such image datasets. It essentially comprises a screen 2 and a data processing unit 3, in particular a personal computer (PC) or a workstation, in which an executable display program 4 is implemented.

In addition, the device 1 optionally comprises an image data memory 5 in which the image datasets that are to be displayed can be stored. The image data memory 5 can be—as depicted in FIG. 1 for reasons of simplification—an intrinsic part of the device 1. Preferably, however, the image datasets that are to be displayed are stored in a device-external image memory, for example a central storage facility of a clinic or other medical establishment, which the device 1 accesses via a data network.

The image datasets that are to be displayed are in particular (computer) tomograms T generated by way of a computed tomography scanner 6 indicated schematically in FIG. 1. In order to transmit the tomograms T, the device 1 is connected to the computed tomography scanner 6 directly, or indirectly by way of the intermediate data network.

From the three-dimensional tomogram T, the display program 4 derives one or more two-dimensional views V and edits the latter in preparation for being displayed on the screen 2. The view V comprises the displayed image plane, in particular an image slice S of the tomogram T. An image slice S in this context refers to a two-dimensional arrangement of pixels mirroring a two-dimensional section through the three-dimensional image information of the tomogram T.

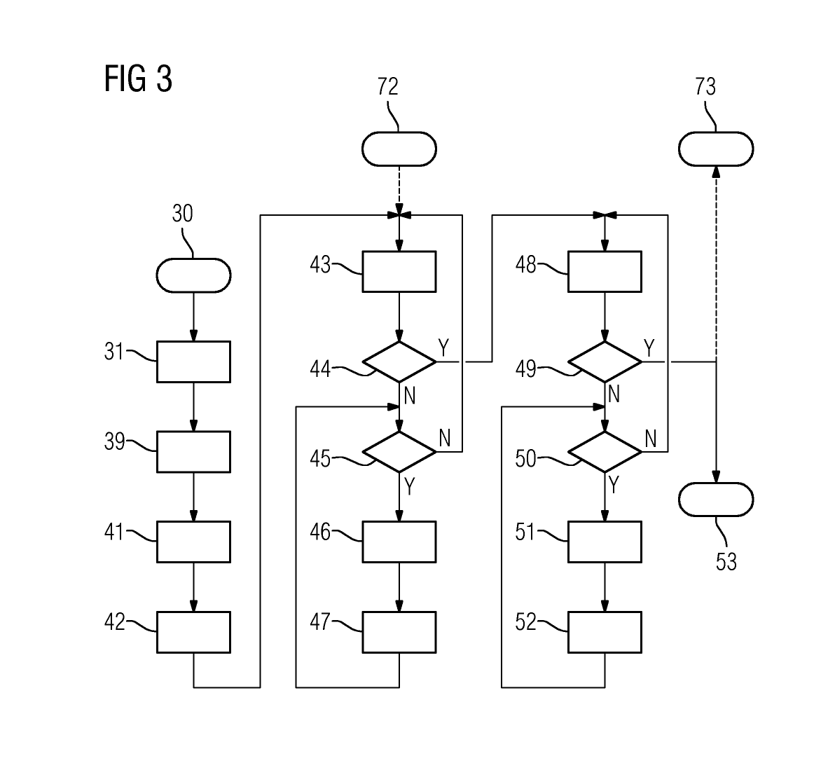

A view V representing such an image slice S is shown by way of example in FIG. 2. Evident in particular in FIG. 2 is the actual image information 10, which stands out in contrasting color from a monochrome background 11 and which for example represents the image of a section through an examined part of a patient's body.

In addition to the pure image information, the view V comprises so-called diagnostic findings. In this context—regardless of its possible medical significance—the term “findings” describes a group of pixels which is marked as belonging together within the image slice S that is to be displayed. FIG. 2 shows by way of example a first set of diagnostic findings 12 which was generated by way of the display program 4 through automatic segmentation of a group of pixels standing out in color from the background and which is the image of a tumor for example. FIG. 2 also shows a second set of diagnostic findings 13 representing a so-called ROI (Region of Interest), i.e. a surface area of the image slice S that has been manually marked by a user of the device 1 e.g. by way of a computer mouse.

Each set of diagnostic findings 12 and 13 is in this case assigned an information field 14 and 15 respectively. Each of the information fields 14 and 15 is a rectangular text field which is overlaid on the pixels of the image slice S and which contains—automatically or manually generated—textual information relating to the associated set of diagnostic findings 12 or 13. The edge of each information field 14 and 15 is connected via a reference line 16 and 17 respectively to the edge of the associated set of diagnostic findings 12 and 13 respectively. In particular the center of the surface area of the associated information field 14 and 15, respectively, and the center of the surface area of the associated set of diagnostic findings 12 and 13, respectively, are used as anchor points between which the respective reference line 16,17 extends, the reference line 16,17 being visibly represented only outside of the text field 14,15 and the set of diagnostic findings 12,13.

In addition to the information fields 14 and 15 each assigned to a set of diagnostic findings 12,13, the view V includes a findings-independent image label. In the example shown in FIG. 2, this image label is formed by a text field 18 in the top left-hand corner of the view V and a (magnitude) scale 19. In this case the text field 18 contains—again automatically or manually generated—textual information relating to the imaged patient, the type of examination, the image-generating modality (in particular the computed tomography scanner 6), as well as to specific examination parameters.

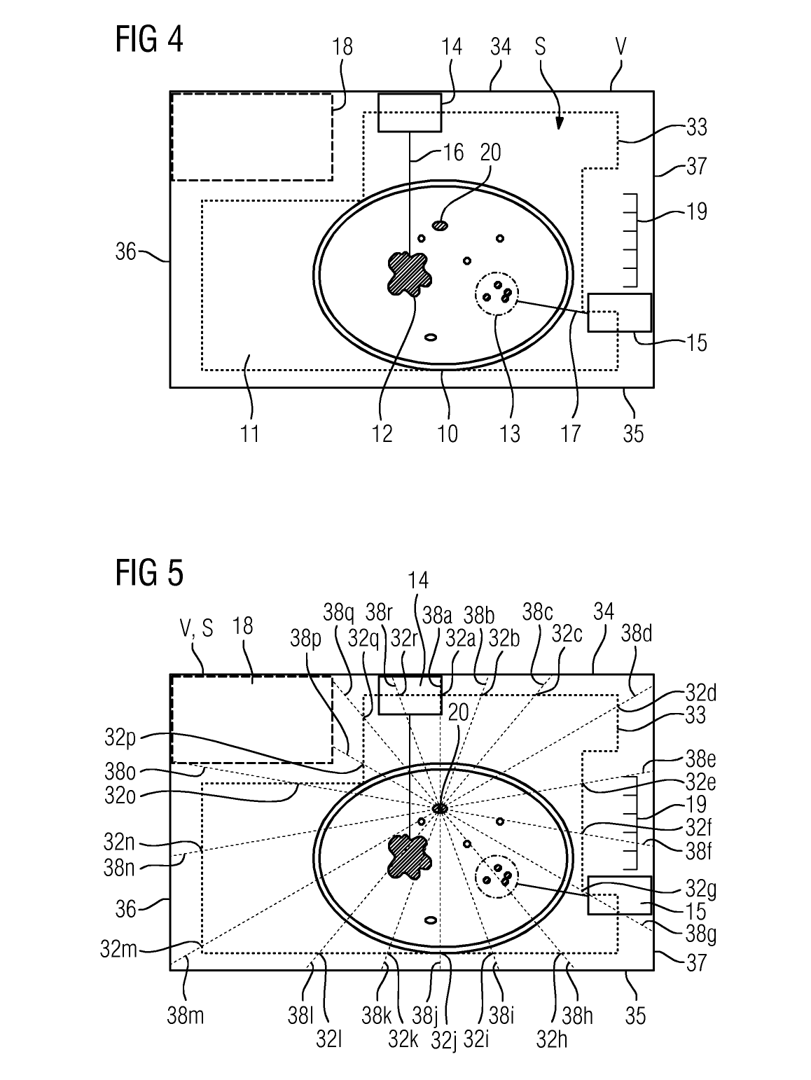

The display program 4 includes a function for generating new diagnostic findings. In this connection the display program 4 offers a user of the device 1 in particular the possibility, by “clicking on” a pixel of the displayed image slice S, of automatically segmenting an image region matching this pixel in color as a new set of diagnostic findings. Alternatively, the display program 4 offers a user of the device the possibility of selecting a new ROI or VOI. In FIG. 2, a contrasting spot of color is drawn in by way of example, which spot of color is for example the image of a newly discovered tumor, and which can be marked as a new set of diagnostic findings 20 by way of automatic segmentation. In order to generate and place a new information field 21 (FIG. 6) assigned to the new set of diagnostic findings 20, the display program 4 automatically performs the method represented schematically in FIG. 3.

According to FIG. 3, the method is started in a step 30 with the generation of the new set of diagnostic findings 20. In a next step 31 the display program 4 determines a number of possible positions 32a-32r (FIG. 5) for the new information field 21.

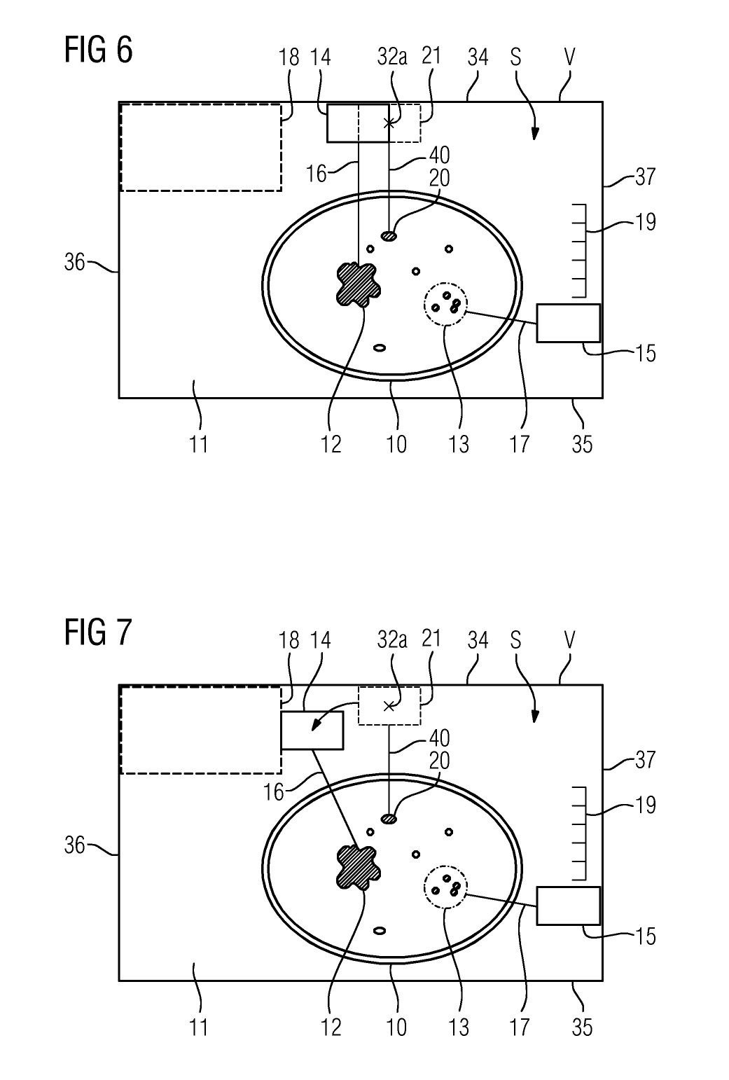

For this purpose the display program 4 first determines a positioning frame 33 (FIG. 4) which, with respect to the top edge 34 and bottom edge 35 of the view V, maintains a clearance equivalent to half the height of the new information field 21. With respect to the two (side) edges 36 and 37 of the view V, the positioning frame 33 has a clearance equivalent to half the width of the new information field 21. The positioning frame 33 is arranged with respect to the edges of the elements of the findings-independent image label, i.e. to the text field 18 and the scale 19, at corresponding intervals in each case. In the vicinity of the findings-independent image label the positioning frame 33 is therefore indented with respect to the edges 34-37 of the view V.

The new information field 21 can thus be shifted along the positioning frame 33 at the edges 34 to 37 of the view V, bypassing the findings-independent image label and consequently never coming into overlap with the text field 18 or the scale 19.

In order to limit the number of possible positions 32a-32r to a manageable quantity, i.e. one that numerically can be readily processed, the display program 4 also generates a ray fan consisting of radial rays 38a to 38r (FIG. 5), which are emitted from the center of the surface area of the new diagnostic findings and are arranged relative to one another at the same angular distance of in this case, for example, 20°.

As can be seen from FIG. 5, the display program 4 in each case assigns a possible position 32a-32r for the new information field 21 to the (possibly innermost) point of intersection of each radial ray 38a to 38r with the positioning frame 33.

Contrary to what is shown in FIGS. 4 and 5, the positioning frame 33 and the radial rays 38a to 38r are virtual lines which do not become part of the view V and accordingly are not visibly represented on the screen 2.

In a following step 39 of the method according to FIG. 3, the possible positions 32a-32r are evaluated by the display program 4.

The evaluation is performed by the display program 4 in accordance with the following criteria:
i) The new information field 21 must not overlap with one of the sets of diagnostic findings 12,13,20.
ii) The information field 21 shall as far as possible be arranged on the background 11 and not overlap with the image information 10.
iii) The clearance of the possible position 32a-32r relative to the center of the surface area of the new set of diagnostic findings 20 (or alternatively the length of the reference line 40 connecting the new set of diagnostic findings 20 with the new information field 21 (FIG. 6)) shall be as small as possible.
iv) The radial ray 38a-38r assigned to the possible position 32a-32r (or alternatively the reference line 40 of the new information field 21) shall as far as possible run parallel to one of the edges 34-37 of the view V, i.e. extend either horizontally or vertically.
v) The information field 21 shall as far as possible touch one of the edges 34-37 of the view V.

As is evident from the formulation of the above-described criteria, the criteria (ii) to (v) are optional criteria, with the result that each of the possible positions 32a-32r will be evaluated all the better, the more of these criteria are fulfilled for the position 32a-32r. In addition, in the case of the criteria (iii) and (iv), each of the possible positions 32a-32r will be evaluated all the better, the better the position 32a-32r satisfies the respective criterion.

The criterion (i), on the other hand, is a required criterion, with the result that a position 32a-32r for which the criterion is not fulfilled will be classified as invalid by the display program 4.

For the numeric evaluation of the position 32a-32r by the display program 4, the optional criteria (ii) to (v) are formulated in the form of the following mathematical equations:
criterion (ii)—overlapping of the new information field with a set of diagnostic findings:

$${f}_{ii} ( n ) = \{ \begin{matrix}1 & if overlap \\ 0 & else\end{matrix} \qquad EQU 1$$

criterion (iii)—distance of the possible position from the center of the surface area of the set of diagnostic findings:

$${f}_{iii} ( n ) = \frac{{d}_{n} - {d}_{min}}{{d}_{max} - {d}_{min}} \qquad EQU 2$$

criterion (iv)—orientation of the fan ray:

fᵢᵥ(n)=1−cos²(2·φₙ) EQU 3
criterion (v)—edge-side position of the new information field:

$${f}_{v} = \{ \begin{matrix}1 & else \\ 0 & edge contract\end{matrix} \qquad EQU 4$$

In EQUs 1 to 4:
n denotes a numerical index n=1,2, . . . for the possible positions 32a-32r and radial rays 38a-38r. The numerical index n has (by way of example) the value 1 for the position 32a or the radial ray 38a and the value 18 for the position 32r or the radial ray 38r,
dₙ denotes the distance of the position 32a-32r having the numerical index n from the center of the surface area of the new set of diagnostic findings 20,
dₘᵢₙ where dₙ=min_{n=1, . . . , 18}[dₙ] denotes the minimum distance of one of the positions 32a-32r from the center of the surface area of the new set of diagnostic findings 20,
dₘₐₓ where dₙ=max_{n=1, . . . , 18}[dₙ] denotes the maximum distance of one of the positions 32a-32r from the center of the surface area of the new set of diagnostic findings 20,
φₙ denotes the angle of incidence of the radial ray 38a-38r having the numerical index n to the vertical; in this case the radial ray 38a has an angle of incidence φ₁=0°, the radial ray 38b an angle of incidence φ₂=20°, etc.

In order to evaluate the positions 32a-32r, the display program 4 calculates the weighted sum from the results of EQUs 1 to 4:

g(n)=cᵢᵢ·fᵢᵢ+cᵢᵢᵢ·fᵢᵢᵢ+cᵢᵥ·fᵢᵥ+cᵥ·fᵥ EQU 5

The weighting factors cii to cv applied in EQU 5 can in principle be chosen arbitrarily within the scope of the invention. In the simplest case all the weighting factors cii to cv are set to the value 1.

From the weighted sum, the display program 4 calculates an evaluation metric E for each possible position 32a-32r according to

$$E ( n ) = \{ \begin{matrix}\frac{{g}_{max} - g ( n )}{{g}_{max} - {g}_{min}} & else \\ - 1 & if criterion ( i ) violated\end{matrix} \qquad EQU 6$$

In the best case the evaluation metric E has the value 1 here and in the worst valid case the value 0. For positions in which the new information field 21 would overlap with a set of diagnostic findings 12,13,20, and which therefore are not valid on account of violating criterion (i), the evaluation metric E has the value −1.

In a next step 41 of the method according to FIG. 3, the display program 4 determines that position 32a-32r which has the best, i.e. in terms of value the largest, evaluation metric E. In the example shown in FIGS. 4 to 7, this is the position 32a. If there are several positions for which the evaluation metric E has the maximum value 1, the display program 4 defines the first of these positions 32a-32r as the best position.

In a following step 42 of the method according to FIG. 3, the display program 4 arranges the new information field 21 at the best position, in the example shown, therefore, at the position 32a (cf. FIG. 6).

In the following the display program 4 resolves any overlapping of the new information field 21 with the already existing information fields 14 and 15.

Toward that end, in a step 43, the display program 4 initially identifies that information field located nearest to the new information field 21 in the clockwise direction and selects the information field as the subject information field under consideration. In a following step 44, the display program 4 tests as an abort condition whether the subject information field is identical to the new information field 21. As long as this is not the case (N), the display program 4 checks in a next step 45 whether the subject information field overlaps with the neighboring information field in the anticlockwise direction.

If this is the case (Y), the display program 4 determines the possible positions (step 46) for the subject information field analogously to step 31 and in a following step 47 shifts the subject information field by one position in the clockwise direction.

The display program 4 then jumps back to step 45. With possible multiple iteration of steps 45 to 47, the display program 4 shifts the subject information field until such time as the latter no longer overlaps with the neighboring information field in the anticlockwise direction, and consequently the check performed in step 45 yields a negative result (N).

In this case the display program 4 jumps back to step 43, hence selecting the next-following information field in the clockwise direction as the subject information field, and executes steps 44 to 47 once again for the information field.

This program loop is run through repeatedly until the display program 4 has arrived once again at the new information field 21 in step 43, with the result that the abort criterion tested in step 44 is now fulfilled (Y).

In this case the display program 4 branches to a program loop formed from steps 48 to 52. This second program loop corresponds to the first program loop formed from steps 43 to 47, all actions being performed in the opposite direction.

In step 48, therefore, that information field is selected which is neighbor to the previously considered subject information field in the anticlockwise direction. In step 50, the display program 4 checks whether the information field overlaps with the neighboring information field in the clockwise direction and in step 52 the subject information field is shifted if necessary in the anticlockwise direction by one of the possible positions determined in step 51 analogously to step 31.

In step 49, a check is carried out analogously to step 44 to determine whether the information field previously selected in step 48 is identical to the new information field 21. If this is the case (Y), the display program 4 terminates the method in a step 53 and presents the view V with the new set of diagnostic findings, the associated newly placed information field, and the (possibly shifted) existing information fields for display on the screen 2 (FIG. 7).

In the example shown in FIGS. 4 to 7, no change in the placement of the information fields 14 and 15 is made during the double pass through the first program loop formed from steps 43 to 47, since the fields do not overlap with the neighboring information fields 15 and 21 respectively in the anticlockwise direction. In the third pass through the first program loop, the display program 4 has once again arrived at the new information field 21 and therefore switches from step 44 into the second program loop formed from steps 48 to 52.

In the first pass through this second program loop, the display program 4 establishes in step 50 that, as shown in FIG. 6, the information field 14 overlaps with the new information field 21 and iteratively shifts the information field 14 by one or more positions until it is arranged free of overlap next to the new information field 21 (FIG. 7).

In a refined variant of the method according to FIG. 3, the display program 4 checks prior to step 53 whether the reference lines of two or more information fields cross over one another as a result of the insertion of the new information field 21 and the rearrangement of the existing information fields. If necessary the display program 4 swaps the information fields around so that the crossover of the reference lines is removed and by making a return branch to step 43 repeats the rearrangement process of the information fields.

In addition or alternatively, the display program 4 enables a user to place one or more information fields by way of user interaction, for example by clicking and moving using a computer mouse. Such manually placed information fields are not shifted in the course of the placement method according to FIG. 3. Rather, such manually placed information fields are either treated as an element of the findings-independent image label or skipped during the placement of the remaining information fields in the event of an overlap.

The display program 4 furthermore enables an image scrolling process to be performed in which a plurality of image slices S of the image dataset T which are aligned in series along the third dimension of the image information are displayed in succession in chronological order. During the course of the scrolling process, diagnostic findings which were visible in the originally displayed image slice S often become hidden from sight, while the image slice S resulting from the scroll process sometimes contains diagnostic findings which could not be seen in the original image slice S.

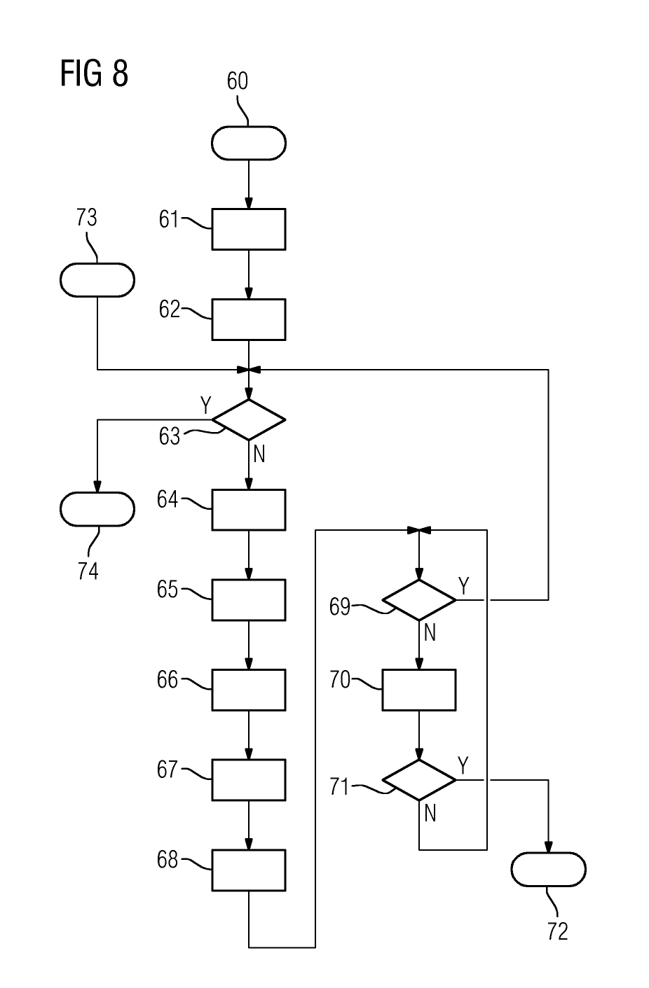

In order on the one hand to achieve the most clearly organized placement possible of the information fields assigned to the sets of diagnostic findings in such a scroll process, but at the same time to avoid a constant rearrangement of the information fields, the display program 4 places the information fields during or after a scroll process according to the method shown in FIG. 8.

This method is started by the display program 4 in a step 60, immediately the scroll process is terminated. In a following step 61, the display program 4 removes all the information fields whose assigned sets of diagnostic findings are no longer to be seen in the resulting image slice S. In a further step 62, the display program 4 determines those diagnostic findings and their associated information fields which are visible in the resulting image slice S, though not in the original image slice S, and which therefore have become visible owing to the scroll process.

In a following step 63, the display program 4 tests as an abort condition whether all the information fields that became visible as a result of the scroll process have already been interpolated. As long as this is not the case (N), the display program 4 selects the next information field to be interpolated in a step 64.

In a step 65, the display program 4 determines, analogously to step 31, the possible positions for the information field that is to be arranged in order, evaluates the positions in a following step 66 analogously to step 39, determines in a step 67, which is equivalent to step 41, the best position—in accordance with the determined evaluation metric—for the information field that is to be arranged in order, and in a step 68 places the information field at the best position.

In a following step 69, the display program 4 checks whether the newly placed information field is arranged free of overlap with existing information fields. As long as this is not the case (N), the display program 4 shifts the newly placed information field by one position in the clockwise direction (step 70). Alternatively hereto, it can be provided in step 70 that the display program 4 shifts the newly placed information field in the anticlockwise direction or tries out (in descending order) the positions determined in step 65 according to the evaluation metric determined in step 66.

After each rearrangement of the newly placed information field the display program 4 checks in a step 71 whether all of the possible positions determined in step 65 have already been tried out. As long as this is not the case (N), the display program 4 branches back to step 69 and accordingly checks the next position for the newly placed information field.

Passes are made through the program loop formed from steps 69 to 71 until such time as either it is established in step 69 that the newly placed information field has been placed free of overlap with the existing information fields, or until it is established in step 71 that none of the positions determined in step 65 allows an overlap-free arrangement of the newly placed information field without a displacement of the existing information fields.

In the former case, i.e. if the condition tested in step 69 is fulfilled (Y), the display program 4 jumps back to step 63 and—after testing the abort condition there—commences with the arrangement of the next information field to be placed.

In the latter case, i.e. if the check carried out in step 71 leads to a positive result (Y), the display program 4 branches to step 43 of the method shown in FIG. 3, accepting the newly placed information field as a new information field within the meaning of the method employed there. After the rearrangement of all the existing information fields according to steps 43 to 52, the display program 4 then jumps back in a step 73 to step 63 of the method according to FIG. 8.

Passes are made through the program loop formed by steps 63 to 71 until such time as all the information fields associated with sets of diagnostic findings which have newly appeared in the course of the scroll process are arranged in order free of overlap, and accordingly the abort condition tested in step 63 has been fulfilled (Y).

In this case the display program 4 terminates the method in a step 74 and once again presents the view V containing the newly placed, and where necessary rearranged, information fields for display on the screen 2.

Although the invention is made particularly clear with the aid of the above-described exemplary embodiment, it is not limited thereto. Rather, further exemplary embodiments of the invention can be derived by the person skilled in the art with reference to the foregoing description. In particular, the display program 4 optionally comprises a zoom function by which, instead of the entire image slice S, a user can interactively select an extract of the same for an enlarged visualization on the screen 2. In this case the view V contains the selected section instead of the entire image slice S. The edges 34-37 of the view V in this case correspond, not to the edges of the image slice S, but to the edges of the displayed section.

What is claimed is:

1. A method for displaying a digital medical image dataset, the medical image dataset including at least one image slice in the form of a two-dimensional arrangement of pixels spanning an image plane; a number of sets of diagnostic findings, each of which is formed by a subgroup of the pixels marked as belonging together; and an information field respectively associated with each of the sets of diagnostic findings, the method comprising:
generating an associated new information field when a new set of diagnostic findings;
determining a number of possible positions for the new information field;
assigning each of the possible positions an evaluation metric in accordance with a number of criteria;
arranging the new information field at the possible position having the relatively best evaluation metric;
shifting each existing information field that overlaps with the new information field until the existing information field is arranged free of overlap with the new information field; and
shifting each other existing information fields that overlap with previously shifted information fields until all of the information fields are arranged free of overlap with one another.

2. The method of claim 1, wherein the possible positions of the new information field are selected such that the new information field does not overlap with any sets of diagnostic findings.

3. The method of claim 1, wherein the image dataset includes an image label which is independent of the sets of diagnostic findings, wherein the possible positions of the new information field are selected such that, in any position, the new information field is arranged free of overlap with the image label, and wherein the existing information fields are shifted such that they are arranged free of overlap with the image label.

4. The method of claim 1, wherein, in order to determine the possible positions of the new information field, a positioning frame in the form of a closed track is determined on the image plane of the image slice or of the displayed section, along which the position of the new information field is shiftable.

5. The method of claim 3, wherein the frame is determined such that in any position, the new information field is arranged free of overlap with the image label.

6. The method of claim 1, wherein, in order to determine the possible positions of the new information field, a fan of radial rays is formed starting from a center chosen within the image plane, and wherein the possible positions are selected such that, in each case, a respective possible position lies on each of the respective radial rays.

7. The method of claim 1, wherein at least one of the following is incorporated positively as a criterion in the evaluation metric:
if the new information field is located outside of contrasting structures of the image slice,
if the new information field touches an edge of the image slice or of the imaged image section,
if the new information field is arranged vertically over or under or horizontally next to the associated set of diagnostic findings on the image plane, and
if the new information field is arranged close to the associated set of diagnostic findings.

8. The method of claim 1, wherein each respective information field is connected by way of a reference line to a predefined anchor point on the edge of or inside of the associated set of diagnostic findings, and wherein the arrangement of the information fields is swapped around if the reference lines of information fields intersect.

9. The method of claim 1, wherein the image dataset is a three-dimensional image dataset including a plurality of, in each case, two-dimensional image slices aligned in series along a third dimension.

10. The method of claim 9, wherein in a scrolling sequence in which a plurality of image slices are displayed in succession, information fields associated with sets of diagnostic findings that are collectively contained in the image slices shown are maintained at their previous position.

11. The method of claim 1, wherein each information field is shiftable anywhere within the image plane by way of user interaction.

12. The method of claim 11, wherein the position of an information field, shifted by way of user interaction, is retained in the event of a rearrangement of the information fields.

13. A device for displaying a digital medical image dataset, the device comprising:
a display unit, configured for visual presentation of digital image data and including a data processing unit on which a display program for editing the image dataset in preparation for display on the display unit is implemented, wherein the display program is configured to perform the method of claim 1.

14. A computer program product comprising computer-readable instructions of a display program, the instructions causing the method of claim 1 to be performed when the display program is executed in a data processing unit.

15. The method of claim 2, wherein the image dataset includes an image label which is independent of the sets of diagnostic findings, wherein the possible positions of the new information field are selected such that, in any position, the new information field is arranged free of overlap with the image label, and wherein the existing information fields are shifted such that they are arranged free of overlap with the image label.

16. The method of claim 2, wherein, in order to determine the possible positions of the new information field, a positioning frame in the form of a closed track is determined on the image plane of the image slice or of the displayed section, along which the position of the new information field is shiftable.

17. The method of claim 4, wherein the frame is determined such that in any position, the new information field is arranged free of overlap with the image label.

18. A computer program product comprising computer-readable instructions of a display program, the instructions causing the method of claim 2 to be performed when the display program is executed in a data processing unit.
